(19) United States
(12) Patent Application Publication
(10) Pub. No.: US 2018/0231167 A1
(43) Pub. Date: Aug. 16, 2018

(54) TEMPERATURE / PRESSURE SENSING VIA HOSE FITTING ASSEMBLY

(71) Applicant: ContiTech USA, Inc., Fairlawn, OH (US)

(72) Inventors: Jack Wallace, Powell, OH (US); Pascal Langlois, Granby (CA); Ronald Marcel Chevalier, Saint-Jean-sur-Richelieu (CA); Zhaoxia Yu, Akron, OH (US)

(73) Assignee: ContiTech USA, Inc., Fairlawn, OH (US)

(21) Appl. No.: 15/897,533

(22) Filed: Feb. 15, 2018

Related U.S. Application Data
(60) Provisional application No. 62/459,655, filed on Feb. 16, 2017.

(51) Int. Cl. F16L 55/07; G01K 13/02; G01L 19/00

(52) U.S. Cl. CPC F16L 55/07; G01K 1/024; G01L 19/0007; G01K 13/02

(57) ABSTRACT

Apparatus include a fitting defining a distal end and conduit, where the fitting has a port inward from the distal end and which extends from the conduit to an outer surface of the fitting. A hose is sealingly connected with the fitting at the distal end, and a temperature measuring device is sealingly secured with the fitting through the port. In some cases, the temperature measuring device and fitting are sealingly secured with mating threaded structures. The temperature measuring device may incorporate RFID technology. Also, the fitting may have a flat region on the peripheral to secure the device. The temperature measuring device may include a temperature measurement component a distal end which is in contact with material resident in the conduit. The temperature measuring device may also have a display and a push button for activating the display, whereby temperature of material resident in the conduit is shown.

### RELATED APPLICATION INFORMATION

This Patent Application claims priority to U.S. Provisional Patent Application No. 62/459,655, filed Feb. 16, 2017, which is incorporated herein in its entirety, by reference.

### FIELD

The field to which the disclosure generally relates to are fittings for hoses that contain static or flowing fluids, such as hoses of the types used in mobile machinery, automotive, petroleum aerospace, manufacturing, and process equipment. More particularly, this invention relates to hydraulic or industrial hoses equipped with apparatus for sensing the status of the hose or materials resident within the hose, as well as methods of use thereof.

### BACKGROUND

This section provides background information to facilitate a better understanding of the various aspects of the disclosure. It should be understood that the statements in this section of this document are to be read in this light, and not as admissions of prior art.

U.S. Pat. No. 9,291,521 B2 describes a hose leakage detection system which includes a ring configured to be disposed within a hose. The ring has a lateral slot formed in an outer surface, defining a first slot wall and a second slot wall. An optical sensor is disposed on one of the first slot wall and the second slot wall and a power source is electrically connected to the leakage detection system.

U.S. Pat. No. 8,997,792 B2 describes a hose abrasion monitoring system which includes a hose assembly a monitoring circuit. The hose assembly includes a hose having at least one conductive layer and at least one outer insulating cover overlaying the at least one conductive layer. The monitoring circuit is in electrical communication with the at least one conductive layer. Upon abrasion of the at least one outer cover to expose a portion of the at least one conductive layer, the monitoring circuit is configured to detect electrical continuity between the at least one conductive layer and a conductive component external to the hose. This reference is incorporated herein by reference thereto.

U.S. Pat. No. 7,555,936 B2 describes a fluid containment vessel having a wall with an innermost layer for contact with the fluid contained by the vessel, and an outermost layer parallel with the innermost layer. The system includes strain-sensing means between the innermost and outermost layers and comprising at least one conductor parallel to the innermost layer of the wall. This reference is incorporated herein by reference thereto.

U.S. Pat. No. 6,386,237 B1 describes a material transport hose having at least two wear sensing elements, each at a specified distance from the inward most surface of the inner tube, and each monitoring a condition indicative of wear of the hose at its specified distance from the inward most surface of the inner tube. When the innermost wear sensing element implies wear, the hose can be repositioned to extend the useful life until the outermost wear sensing element indicates wear requiring replacement of the hose.

U.S. Pat. No. 8,528,385 B2 describes a hose leakage detection system includes a ring configured to be disposed within a hose. The ring has a lateral slot formed in an outer surface, defining a first slot wall and a second slot wall. An optical sensor is disposed on one of the first slot wall and the second slot wall and a power source is electrically connected to the leakage detection system. This reference is incorporated herein by reference thereto.

U.S. Pat. No. 8,087,430 B1 describes a leak detecting hose for transporting fluid. The hose has an inner layer and an outer layer. The outer layer circumscribes the inner layer. A transition layer is located between the inner and outer layer, and the transition layer provides a flow path for the fluid in the hose when the inner layer is breached. A first conductive wire is placed in contact with the transition layer, and a second conductive wire is placed in contact with the transition layer. The conductive wires are adjacent to and spaced from each other. When the inner layer of the hose is breached, the first and second wires will contact the fluid in the flow path. This reference is incorporated herein by reference thereto.

Leaks of materials conveyed through hoses, due to failure of such hoses due to improper temperature and/or pressure, are generally undesirable, and may even lead to catastrophic results in some cases. Although unique methods of detecting leaks are described in the current state of the art, there is always the potential that leaks could be missed by the current methodologies, if the leak is highly localized, or does not change the variable that is being measured in the current methods. Furthermore, leaks of materials resident or conveyed in the hose may lead to safety issues, hazardous conditions, regulatory non-compliance situations, and/or loss of material and downtime. Thus, there is an ongoing need for improved hose apparatus monitoring/detection systems and methodologies for pressure and temperature conditions, such need met at least in part with embodiments according to the following disclosure.

### SUMMARY

This section provides a general summary of the disclosure, and is not a necessarily a comprehensive disclosure of its full scope or all of its features.

In some aspects of the disclosure, apparatus include a fitting defining a distal end and conduit, where the fitting has a port inward from the distal end and which extends from the conduit to an outer surface of the fitting. A hose is sealingly connected with the fitting at the distal end, and a temperature measuring device is sealingly secured with the fitting through the port. In some cases, the temperature measuring device and fitting are sealingly secured with mating threaded structures. The temperature measuring device may incorporate RFID sensor technology. Also, the fitting may further have a flat region on the peripheral to further secure the device. The temperature measuring device may further include a temperature measurement component disposed on a distal end which is in direct contact with material resident in the conduit. The temperature measuring device may also have a display and a push button for activating the display, whereby temperature of material resident in the conduit is shown on the display.

Other aspects of the disclosure include apparatus having a fitting defining a distal end and conduit, the fitting including a port inward from the distal end and which extends from the conduit to an outer surface of the fitting. A hose is sealingly connected with the fitting at the distal end, and a pressure measuring device is sealingly secured with the fitting through the port. The pressure measuring device and fitting may be sealingly secured with mating threaded structures. The pressure measuring device may incorporate RFID sensor technology. The fitting may further have a flat region on the peripheral to secure the pressure measuring device. The pressure measuring device may further have a pressure measurement component on a distal end which is in direct contact with material resident in the conduit. Also, the pressure measuring device may include a display and a push button for activating the display, whereby pressure of material resident in the conduit is shown on the display.

Yet other aspects of the disclosure are methods which include providing an apparatus with a fitting defining a distal end and conduit, and the fitting has a port inward from the distal end and which extends from the conduit to an outer surface of the fitting. A hose is sealingly connected with the fitting at the distal end, and a measuring device sealingly secured with the fitting through the port. At least one property of material resident in the conduit is measured via the measuring device. The at least one property measured may be temperature or pressure.

### BRIEF DESCRIPTION OF THE DRAWINGS

Certain embodiments of the disclosure will hereafter be described with reference to the accompanying drawings, wherein like reference numerals denote like elements. It should be understood, however, that the accompanying figures illustrate the various implementations described herein and are not meant to limit the scope of various technologies described herein, and:

FIGS. 1A-1C shows an apparatus in accordance with the disclosure, in a perspective view (FIG. 1A), a side view (FIG. 1B) and an end view (FIG. 1C)

FIGS. 2A-2C illustrate an apparatus according to the disclosure, in a perspective view (FIG. 2A), an end view (FIG. 2B) and a side view (FIG. 2C); and,

FIG. 3 illustrates an apparatus according to the disclosure, in a perspective view.

### DESCRIPTION

The following description of the variations is merely illustrative in nature and is in no way intended to limit the scope of the disclosure, its application, or uses. The description is presented herein solely for the purpose of illustrating the various embodiments of the disclosure and should not be construed as a limitation to the scope and applicability of the disclosure. In the summary of the disclosure and this detailed description, each numerical value should be read once as modified by the term “about” (unless already expressly so modified), and then read again as not so modified unless otherwise indicated in context. Also, in the summary of the disclosure and this detailed description, it should be understood that a value range listed or described as being useful, suitable, or the like, is intended that any and every value within the range, including the end points, is to be considered as having been stated. For example, “a range of from 1 to 10” is to be read as indicating each and every possible number along the continuum between about 1 and about 10. Thus, even if specific data points within the range, or even no data points within the range, are explicitly identified or refer to only a few specific, it is to be understood that inventors appreciate and understand that any and all data points within the range are to be considered to have been specified, and that inventors had possession of the entire range and all points within the range.

Unless expressly stated to the contrary, “or” refers to an inclusive or and not to an exclusive or. For example, a condition A or B is satisfied by anyone of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of concepts according to the disclosure. This description should be read to include one or at least one and the singular also includes the plural unless otherwise stated.

The terminology and phraseology used herein is for descriptive purposes and should not be construed as limiting in scope. Language such as “including,” “comprising,” “having,” “containing,” or “involving,” and variations thereof, is intended to be broad and encompass the subject matter listed thereafter, equivalents, and additional subject matter not recited.

Also, as used herein any references to “one embodiment” or “an embodiment” means that a particular element, feature, structure, or characteristic described in connection with the embodiment is included in at least one embodiment. The appearances of the phrase “in one embodiment” in various places in the specification are not necessarily referring to the same embodiment.

The field to which the disclosure generally relates to is apparatus that contain static or flowing fluids, such as hoses of the types used in mobile machinery, automotive, petroleum aerospace, manufacturing, and process equipment. More particularly, this invention relates to hydraulic or industrial hose fittings equipped with apparatus for sensing temperature and/or pressure of material contained in the hose and fitting, as well as methods of use thereof.

In accordance with some aspects of the disclosure, apparatus a hose sealingly mated with a fitting, where the fitting includes a device incorporated for measuring the real time temperature and/or pressure of material contained in the apparatus, or the fitting and apparatus themselves. The arrangement gives rise to a capability of monitoring the real time temperature and/or pressure of a hose while in use, as well as providing the thermal and/or pressure cycling history of a given hose to offer better predictive life estimates for such hose.

In some aspects, one or more temperature and/or pressure measuring radio frequency identification (RFID) sensor technology devices may be integrated into the apparatus, perhaps within the fitting in some cases, which uniquely identifies the hose being measured, provides instantaneous temperature and/or pressure measurements (i.e. wirelessly, via display, etc.), as well as to log the thermal and/or pressure cycling history of the hose for better servicing. In some embodiments, the RFID sensor technology devices may be incorporated with existing fitting designs, such as Insta-Lock™ fittings, as well as other general purpose fittings.

Advantages provided by embodiments according to the disclosure are also easily measuring temperature and/or pressure of the material (i.e. fluid, slurry, etc.) being conveyed by the apparatus via a device integrated within the fitting in an effort to better control the process, flag potential thermal and/or pressure issues in the process, as well as improve the preventative maintenance procedures at a facility.

Some embodiments according to the disclosure utilize a RFID sensor technology containing device with on board temperature and/or pressure measurement capability, as well as media for data storage with timestamps (i.e. measured data logging). The device may be able to allow measured data to be recovered by another device (i.e. handheld device, remote computer, etc.) via communication by wireless connection, Bluetooth, etc. The device may further include a battery, and be of a design to sealingly integrate into a fitting in the apparatus, where temperature and/or pressure measurements are targeted. In an alternate embodiment, a thermocouple arrangement is integrated into the fitting, and RFID sensor technology is remote from the thermocouple, but in data communication therewith.

Some embodiments according to the disclosure may be continuous service without a battery (i.e. energy harvest via RF reader, etc.). Some measurement interfaces may use direct surface contact (on board), while in some other cases, measurement interfaces are embedded probes (tapped bolt thermocouples).

It is within the scope of the disclosure to use the apparatus described herein in a wireless data collection scenario, or even cloud computing environment. Furthermore, apparatus according to the disclosure may be used in conjunction with, or as a further feature of, other arrangements which include the same or proximate fitting, and a hose sealingly connected with the fitting, where the hose includes a plurality of wires incorporated therein for measuring electrical properties within the hose to determine the of leakage state of the arrangement. Some examples of such arrangements include those apparatus described in U.S. Prov. Pat. App. Ser. No. 62/459,449, which has also been filled as PCT/US18/18284, the disclosures of which are incorporated herein in its entirety by reference. In some other applications, some embodiments of the disclosure may be usefully for pulley bearing casing temperature monitoring in conveyor belt applications.

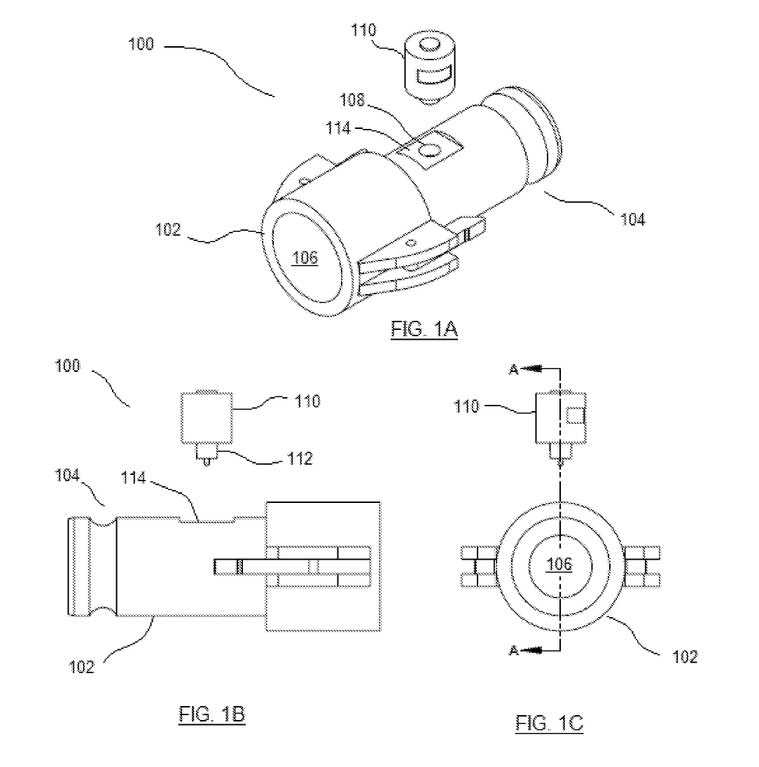

Now referencing FIGS. 1A-10, which illustrate apparatus 100 according to the disclosure, in a perspective view (FIG. 1A), side view (FIG. 1B) and end view (FIG. 1C). Accordingly, apparatus 100 includes a fitting 102 which is sealingly mated with a distal end portion of a hose (not shown) at end 104 of fitting 102. Fitting 102 further defines conduit or passageway 104 for containing and/or conveying material through apparatus 100. Fitting 102 also includes port 108 for accepting and sealingly securing temperature and/or pressure sensor device 110 therein. Any suitable structure or material may be used for integrating and sealingly securing device 110 with fitting 102, including, but not limited to, threaded structure, taper compression fit, weld, cement, sealing tape, and the like, or any combination thereof. Likewise, device 110 includes a mating structure on portion 112 to sealingly engage with fitting 102. A flat region 114 may be formed on the peripheral exterior of fitting 102 to further secure device 110.

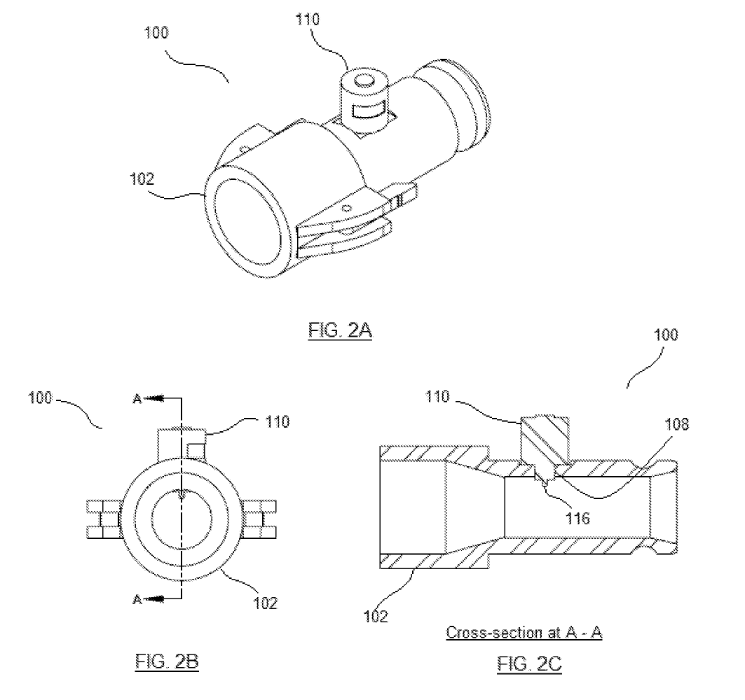

With reference to FIGS. 2A-2C, which illustrate apparatus 100 described above, in a perspective view (FIG. 2A), end view (FIG. 2B) and cross-sectional view (FIG. 2C) where the cross-section is taken at A-A in FIG. 2B. In this set of figures, apparatus 100 is depicted where fitting 102 and device 110 are integrated and sealingly secured at port 108. In some aspects, device 110 includes a temperature and/or pressure measurement component 116 on a distal end.

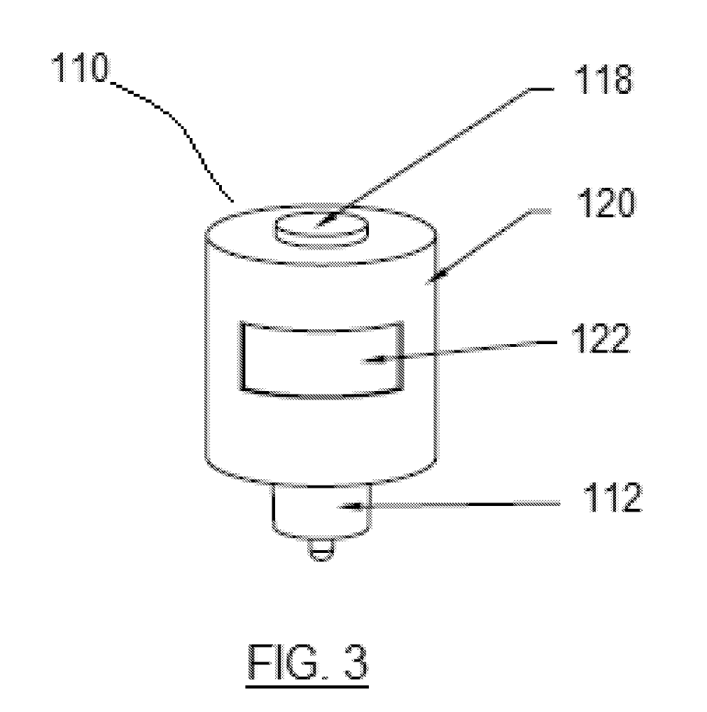

In some embodiments, device 110 may have additional components, such as those shown in FIG. 3. For example device 110 may include a push button 118 which moves freely relative housing 120. When push button 118 is pressed, or otherwise triggered, a measured property, such as temperature and/or pressure are shown on display 122. An additional benefit of using such a push button 118, or other triggering feature, is conservation of battery power. Furthermore, a thermocouple may be integrated into portion 112.

The foregoing description of the embodiments has been provided for purposes of illustration and description. Example embodiments are provided so that this disclosure will be sufficiently thorough, and will convey the scope to those who are skilled in the art. Numerous specific details are set forth such as examples of specific components, devices, and methods, to provide a thorough understanding of embodiments of the disclosure, but are not intended to be exhaustive or to limit the disclosure. It will be appreciated that it is within the scope of the disclosure that individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

Also, in some example embodiments, well-known processes, well-known device structures, and well-known technologies are not described in detail. Further, it will be readily apparent to those of skill in the art that in the design, manufacture, and operation of apparatus to achieve that described in the disclosure, variations in apparatus design, construction, condition, erosion of components, and gaps between components may present, for example.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

Although a few embodiments of the disclosure have been described in detail above, those of ordinary skill in the art will readily appreciate that many modifications are possible without materially departing from the teachings of this disclosure. Accordingly, such modifications are intended to be included within the scope of this disclosure as defined in the claims.

What is claimed is:

1. An apparatus comprising:
a. a fitting defining a distal end and conduit, the fitting comprising a port inward from the distal end and which extends from the conduit to an outer surface of the fitting;
b. a hose sealingly connected with the fitting at the distal end; and,
c. a temperature measuring device sealingly secured with the fitting through the port.

2. The apparatus according to claim 1, wherein the temperature measuring device and fitting are sealingly secured with mating threaded structures.

3. The apparatus according to claim 1, wherein the temperature measuring device incorporates RFID sensor technology.

4. The apparatus according to claim 1, wherein the fitting further comprises a flat region on the peripheral to further secure the device.

5. The apparatus according to claim 1, wherein the temperature measuring device further comprises temperature measurement component on a distal end which is in direct contact with material resident in the conduit.

6. The apparatus according to claim 1, wherein the temperature measuring device further comprises a display and a push button for activating the display, whereby temperature of material resident in the conduit is shown on the display.

7. An apparatus comprising:
a. a fitting defining a distal end and conduit, the fitting comprising a port inward from the distal end and which extends from the conduit to an outer surface of the fitting;
b. a hose sealingly connected with the fitting at the distal end; and,
c. a pressure measuring device sealingly secured with the fitting through the port.

8. The apparatus according to claim 7, wherein the pressure measuring device and fitting are sealingly secured with mating threaded structures.

9. The apparatus according to claim 7, wherein the pressure measuring device incorporates RFID sensor technology.

10. The apparatus according to claim 7, wherein the fitting further comprises a flat region on the peripheral to further secure the pressure measuring device.

11. The apparatus according to claim 7, wherein the pressure measuring device further comprises pressure measurement component on a distal end which is in direct contact with material resident in the conduit.

12. The apparatus according to claim 7, wherein the pressure measuring device further comprises a display and a push button for activating the display, whereby pressure of material resident in the conduit is shown on the display.

13. A method comprising:
a. providing an apparatus comprising:
i. a fitting defining a distal end and conduit, the fitting comprising a port inward from the distal end and which extends from the conduit to an outer surface of the fitting;
ii. a hose sealingly connected with the fitting at the distal end; and,
iii. a measuring device sealingly secured with the fitting through the port; and,
b. measuring at least one property of material resident in the conduit.

14. The method according to claim 13, wherein the at least one property comprises temperature.

15. The method according to claim 13, wherein the at least one property comprises pressure.

16. The method according to claim 13, wherein the measuring device further comprises a display and a push button for activating the display, whereby at least one measured property of material resident in the conduit is shown on the display as the push button is pressed, and pressing the push button.
